(19) United States
(12) Patent Application Publication
(10) Pub. No.: US 2010/0003852 A1
(43) Pub. Date: Jan. 7, 2010

(54) ELECTRICAL CONNECTOR WITH IMPROVED GROUNDING

(75) Inventors: John Mark MYER, Millersville, PA (US); John Wesley HALL, Harrisburg, PA (US); Hurley Chester MOLL, Hershey, PA (US)

Correspondence Address: TYCO TECHNOLOGY RESOURCES, 4550 NEW LINDEN HILL ROAD, SUITE 140, WILMINGTON, DE, 19808-2952, US

(73) Assignee: TYCO ELECTRONICS CORPORATION, Berwyn, PA (US)

(21) Appl. No.: 12/168,807

(22) Filed: Jul. 7, 2008

(51) Int. Cl. H01R 13/648

(52) U.S. Cl. 439/607.17; 439/607.01

(57) ABSTRACT

A shielded electrical connector is disclosed that includes a receptacle having a outer ground shield surrounding a dielectric cover. The dielectric cover includes a plug reception cavity and has an electrical contact and an inner ground shield disposed therewithin. The outer ground shield includes grounding features configured to ground the outer shield to a module wall and attachment features configured to attach and ground the outer shield to a substrate.

### FIELD OF THE INVENTION

The present invention is generally directed to an electrical connector, and more particularly, to a shielded electrical connector having an outer ground shield including a grounding feature for grounding the outer ground shield to a module wall.

### BACKGROUND OF THE INVENTION

Shielded connectors are known to have a conductive shell disposed around a dielectric housing and at least one contact disposed in the housing extending from a device mounting face to a mating face. Such a shielded connector is disclosed in U.S. Pat. No. 6,821,150, which is incorporated herein by reference in entirety. The shielded connector and the contact(s) may be adapted for right angle mounting on the device mounting face, or alternatively, they may be designed for a vertical connection from the device mounting face. The device may be a printed circuit board (PCB) and the connector may be providing a coaxial connection between the PCB and an external device.

The conductive shell, also know as an outer ground shield, is disposed around the dielectric housing to provide shielding from electromagnetic interference (EMI). The ground shield includes ground contacts which are connected to ground circuits of the PCB upon which the shielded connector is mounted.

In one application, the shielded connector may be a shielded receptacle connector attached to a PCB and used to connect the PCB to a plug connector. The receptacle connector may abut a wall or structure of a module housing the PCB. In this application, the module wall includes an opening through which the plug connector passes through to mate with a corresponding receptacle connector. It is important that the ground shield be securely grounded to both the PCB and the wall or other module structure abutting the receptacle connector to provide effective EMI shielding. In the past, shields have been independently secured to the wall or module structure by a separate grounding connection.

Therefore, there is an unmet need to provide a shielded connector having a mechanism for securely grounding the ground shield to a wall or structure abutting the shielded connector.

### SUMMARY OF THE INVENTION

According to an embodiment of the invention, a shielded connector is disclosed that includes a receptacle connector and a plug connector. The receptacle connector includes a dielectric cover, a receptacle contact disposed within the dielectric cover; and an outer ground shield surrounding the dielectric cover. The dielectric cover includes a plug reception cavity having an opening thereto. The outer ground shield includes a top wall, side walls, a rear wall and a bottom wall. The outer ground shield further includes grounding features proximate to the dielectric cover shield front opening and attachment features. The plug connector includes a dielectric housing having a cable including a conductor terminated therewithin. The plug connector is configured to mate with the receptacle connector to establish an electrical connection between the conductor and the receptacle contact.

According to another embodiment of the invention, a shielded receptacle is disclosed that includes a dielectric cover including a plug reception cavity having an opening thereto, a receptacle contact disposed within the dielectric cover, and an outer ground shield surrounding the dielectric cover. The outer ground shield comprises a top wall, side walls, a rear wall and a bottom wall. The outer ground shield further comprises grounding features proximate to the dielectric cover shield front opening and attachment features.

Further aspects of the method and system are disclosed herein. The features as discussed above, as well as other features and advantages of the present invention will be appreciated and understood by those skilled in the art from the following detailed description and drawings.

### BRIEF DESCRIPTION OF THE DRAWINGS

FIG. 1 illustrates a front perspective view of an exemplary mated electrical connector according to an embodiment of the present invention.

FIG. 2 illustrates a rear perspective view of an exemplary receptacle connector according to an embodiment of the present invention.

FIG. 3 illustrates the perspective view of the electrical connector of FIG. 1 unmated and having the module wall removed.

FIG. 4 illustrates a rear perspective view of the receptacle connector of FIG. 2 detached from the substrate.

FIG. 5A illustrates an exploded top perspective view of an exemplary receptacle connector according to an embodiment of the present invention.

FIG. 5B illustrates a bottom perspective view of the exploded view of FIG. 5A.

FIG. 6 illustrates a cross sectional view of the electrical connector of FIG. 1 taken along line 6-6.

Wherever possible, the same reference numbers will be used throughout the drawings to refer to the same or like parts

### DETAILED DESCRIPTION OF THE INVENTION

The present invention now will be described more fully hereinafter with reference to the accompanying drawings, in which a preferred embodiment of the invention is shown. This invention may, however, be embodied in many different forms and should not be construed as limited to the embodiments set forth herein; rather, these embodiments are provided so that this disclosure will fully convey the scope of the invention to those skilled in the art.

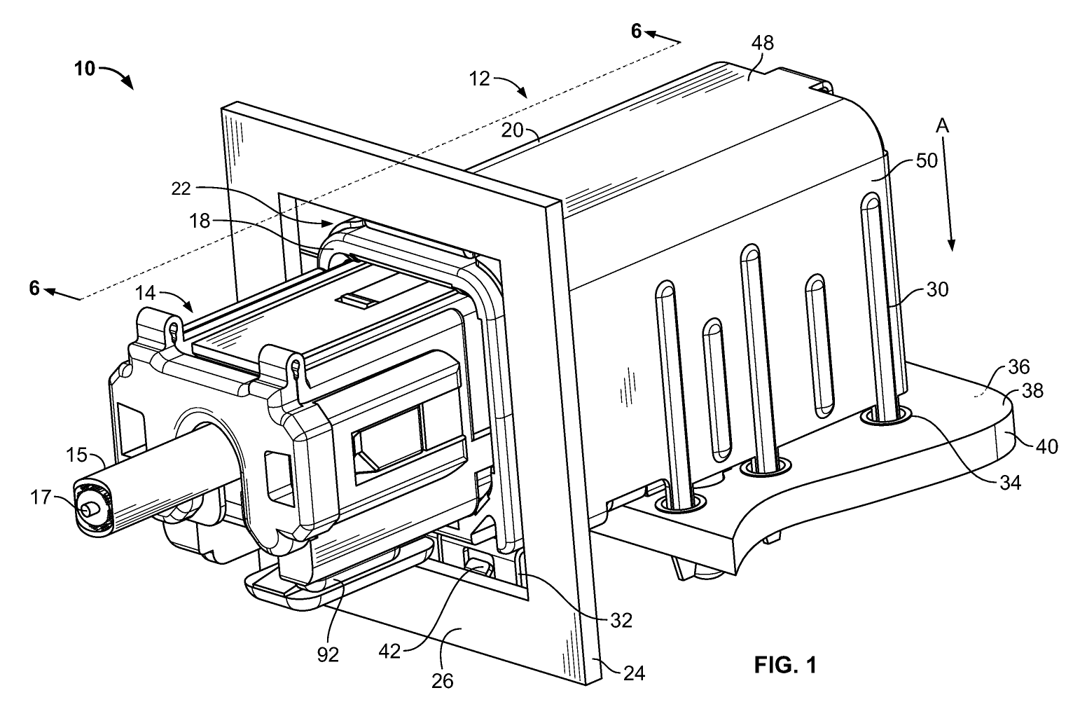

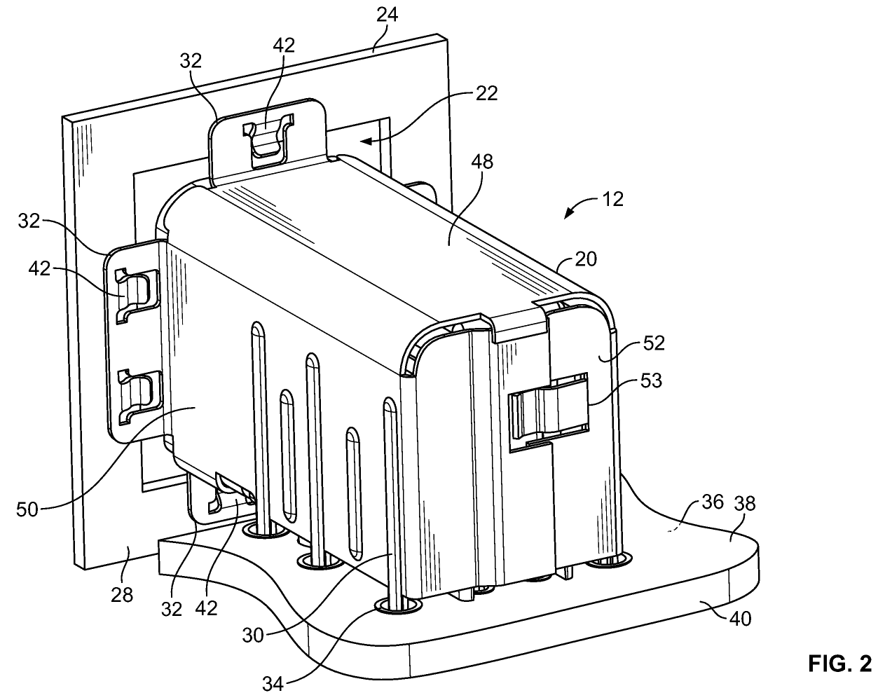

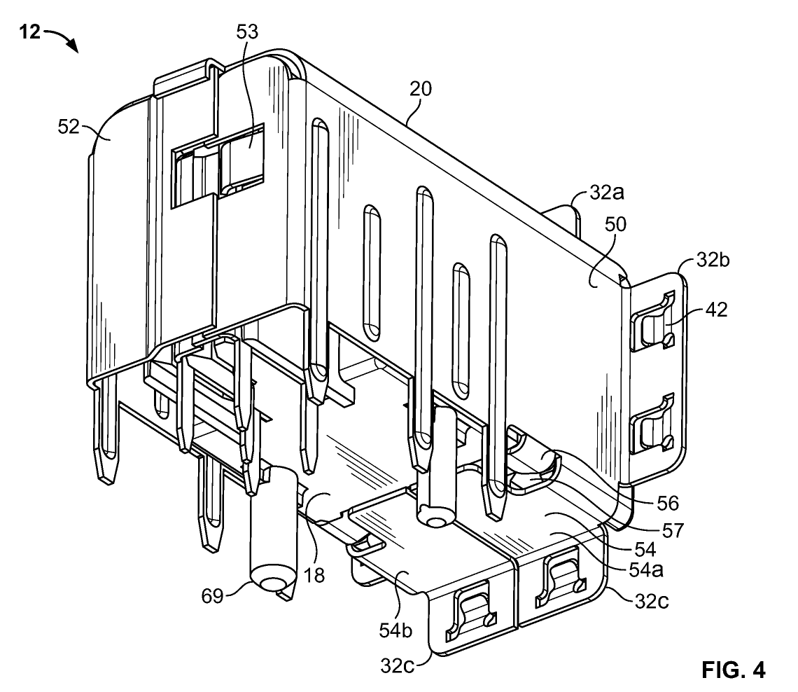

FIG. 1 shows an exemplary mated electrical connector 10 according to the invention. The electrical connector 10 includes a receptacle connector 12 and a plug connector 14. The receptacle connector 10 is configured to be attached to a substrate 36, only a portion of which is shown in FIG. 1. The substrate 36 may be a printed circuit board (PCB). The receptacle connector 12 includes a dielectric cover 18 and an outer ground shield 20. The outer ground shield 20 includes a top wall 48, opposing side walls 50, a rear wall 52 (FIG. 2), and a bottom wall 54 (FIG. 4). The plug connector 14 includes a plug outer housing 92. The plug outer housing 92 is configured to receive a plug wire or plug cable 15 containing a conductor 17 securely disposed and terminated therewithin. In one embodiment the plug cable 15 is a coaxial cable. The plug connector 14 is generally further described in U.S. Pat. No. 6,736,653, entitled “Electrical Connector Assembly for Coaxial Cables,” granted May 18, 2004, which is incorporated by reference herein in its entirety.

The receptacle connector 12 and plug connector 14 are mated through a module opening 22 in a module wall 24. The module wall 24 may be any part of a housing (not shown) supporting the PCB. The module wall 24 includes an exterior surface 26 and an interior surface 28 (FIG. 2). In this exemplary embodiment, the module wall 24 is perpendicular to the PCB. In one embodiment, the module wall 24 may be formed of a conductive material and may be electrically grounded. T In another embodiment, the module wall 24 may include conductive ground traces, wires or other conductive ground pathways (not shown) disposed on the interior surface 28 (FIG. 2). In yet another embodiment, the module wall 24 may be a module wall of a substrate housing (not shown). In still another embodiment, the module wall 24 may be a module wall of a printed circuit board (PCB) housing.

The outer ground shield 20 includes attachment features 30 and grounding features 32. In this exemplary embodiment, the grounding features 32 are tabs and the attachment features 30 are posts. The outer ground shield 20 is shown including six posts 30 (three posts are present, but not shown, on the opposite side of the outer ground shield 20). In another embodiment, the outer ground shield 20 may include one or more posts 30. The posts 30 are received in corresponding cavities 34 of a substrate 36. In this exemplary embodiment, the substrate 36 is a printed circuit board (PCB). The receptacle connector 12 is configured to be mounted on the PCB 36 in the direction of arrow A as shown. The posts 30 may be soldered, press-fit or otherwise securely received in the cavities 34 to securely attach the receptacle connector 12 to the PCB 36. The PCB 36 may include traces, wires or other conductive ground paths (not shown). The conductive ground paths may be provided on a top surface 38, a bottom surface (not shown), interior 40, or any combination thereof of the PCB 36. The conductive path(s) may extend into at least one cavity 34. At least one post 30 is conductively connected to the conductive ground path of the PCB 36 to ground the outer ground shield 20 thereto. The post(s) 30 may be conductively connected to the conductive path by contact, solder or other similar method. In another embodiment, the attachment points may be tails, tabs, or other attachment structures that provide a conductive termination to the PCB 36.

FIG. 2 shows a rear view of the receptacle connector of FIG. 1. As can be seen in FIG. 2, the tabs 32 include a compliant grounding feature 42, which electrically ground the outer ground shield 20 to the module wall 24. In this exemplary embodiment, the compliant grounding features 42 are torsion springs. As shown in FIG. 2, the tabs 32 vary in size. Also, the tabs 32 vary in the number of torsion springs 42 included thereon. In this exemplary embodiment, some tabs 32 contain one torsion spring 42, while other tabs 32 include two torsion springs 42. In another embodiment, the size of the tabs 32 may all be equal. In yet another embodiment, each tab 32 may contain one or more torsion springs 42. In still another embodiment, the tabs 32 may include other compliant grounding features including, but not limited to, grounding fingers, springs, beam members or other normal force generating structures configured to positively engage the interior surface 28 of the module wall 24.

The torsion springs 42 are configured to positively engage the interior surface 28 of the module wall 24 to electrically ground the outer ground shield 20 thereto. The term “positively engage” is used herein to mean that the torsion springs 42 apply a positive contact force to the interior surface 28 of the module wall 24. In one embodiment the positive contact force is a positive normal contact force.

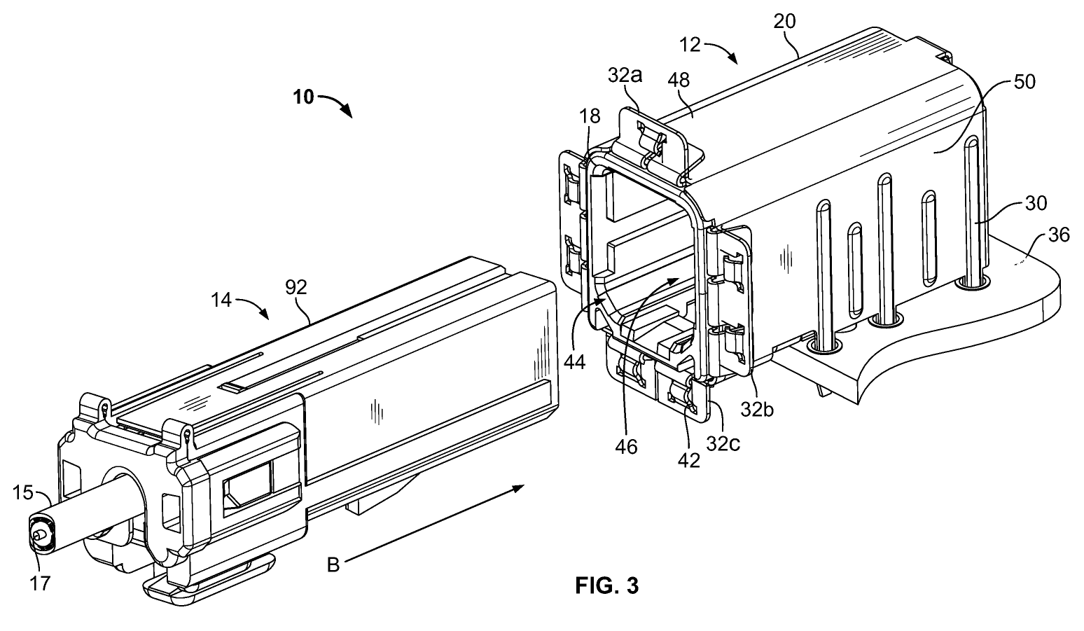

FIG. 3 shows the unmated electrical connector of FIG. 1 with the module wall 24 removed. As can be seen in FIG. 3, the dielectric cover 18 of the receptacle connector 12 includes a front opening 44, which opens to a plug reception cavity 46. The plug connector 14 is received in the front opening 44 in a direction indicated by arrow B to mate the plug connector 14 and receptacle connector 12. As shown in FIG. 3, the front opening 44 has disposed proximate thereto, a top tab 32a, side tabs 32b, and bottom tabs 32c. The top tab 32 adjoins an outer shield top wall 48. The side tabs 32b adjoin outer shield side walls 50. The bottom tabs 32c adjoin bottom wall 54 (FIG. 4). In this exemplary embodiment, the outer ground shield 20 includes five tabs 32, numbered 32a, 32b, 32b, 32c and 32c. In another embodiment, the outer ground shield 20 may include one or more tabs 32. In yet another embodiment, one or more tabs 32 may be disposed on one or more of the outer shield walls.

FIG. 4 shows a rear perspective view of the receptacle connector 12 of FIG. 3 removed from the substrate 36. As can further be seen in FIG. 4, the outer ground shield 18 includes an outer shield bottom wall 54. In this exemplary embodiment, the outer shield bottom wall 54 is formed of two outer shield bottom wall portions 54a, 54b. In this exemplary embodiment, the outer shield bottom wall portions 54a, 54b are of equal size, however, in another embodiment, the outer shield bottom wall portions 54a, 54b may vary in size. The bottom tabs 32c adjoin outer shield bottom wall portions 54a, 54b. As can also be seen in FIG. 4, the outer shield rear wall 52 includes a rear shield contact feature 53. In this exemplary embodiment, the rear shield contact feature 53 is a rear contact tab.

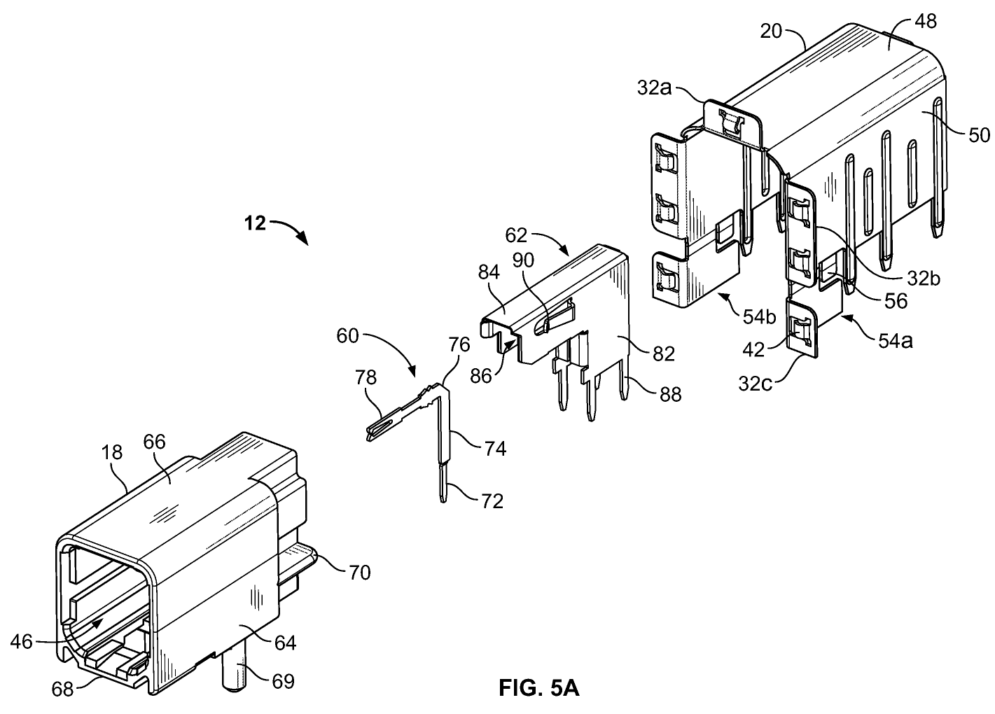

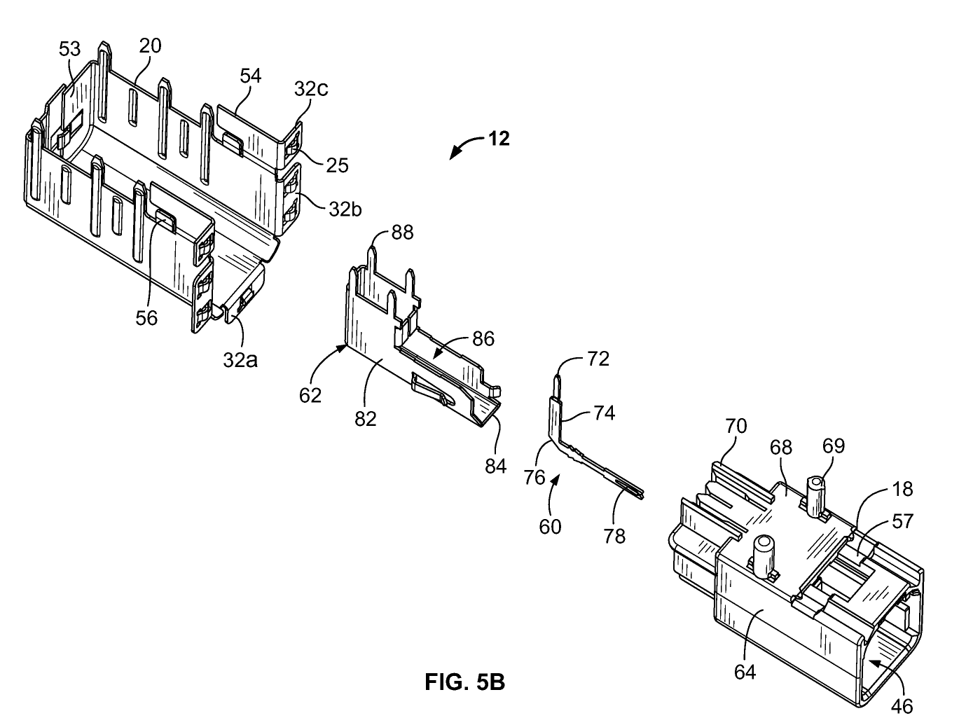

FIGS. 5A and 5B show and exploded view of the receptacle connector 12. As can be seen in FIGS. 4, 5A and 5B, the outer shield bottom wall 54 is formed by folding outer shield bottom wall portions 54a, 54b as indicated by the arrows toward the dielectric cover 18. In this exemplary embodiment, the bottom wall 54 is formed by two bottom wall portions 54a, 54b, and each bottom wall portion 54a, 54b includes one tab 32c and each tab includes one torsion spring 42. In another embodiment, the bottom wall 54 may be formed by only one bottom wall portion 54. For example, the bottom wall 54 may be formed by one modified bottom wall portion (not shown) that adjoins one side wall 50 and extends to the opposite side wall 50. In this yet another embodiment, the modified bottom wall portion may include one or more grounding features including one or more torsion springs 42.

As can also be seen in FIGS. 4, 5A, and 5B, the outer ground shield 20 includes bottom assembly tabs 56 that are folded and received into bottom assembly recesses 57 of the dielectric cover 18 to securely position the dielectric cover 18 within the outer ground shield 20.

As can be further seen in FIGS. 5A and 5B, the receptacle connector 12 further includes a receptacle contact 60 and an inner ground shield 62, which are disposed within the dielectric cover 18 when the receptacle contact 12 is assembled. The dielectric cover 18 can also be more clearly seen in FIGS. 5A and 5B. As can be seen in FIGS. 5A and 5B, the dielectric cover 18 includes side walls 64, a top wall 66, and a bottom wall 68, which define a plug reception cavity 46. The dielectric cover 18 further includes a rear portion 70. The bottom wall 68 includes assembly posts 69 that are received in corresponding post through-holes (not shown) in PCB 36 (FIG. 3).

The receptacle contact 60 and inner ground shield 62 are received into corresponding slot features in the rear portion 70 of the dielectric cover 18, and are disposed therewithin when assembled. The dielectric cover 18 is configured to electrically isolate the receptacle contact 60 from the inner ground shield 62. The receptacle contact 60 is substantially surrounded by the inner ground shield 62 when assembled.

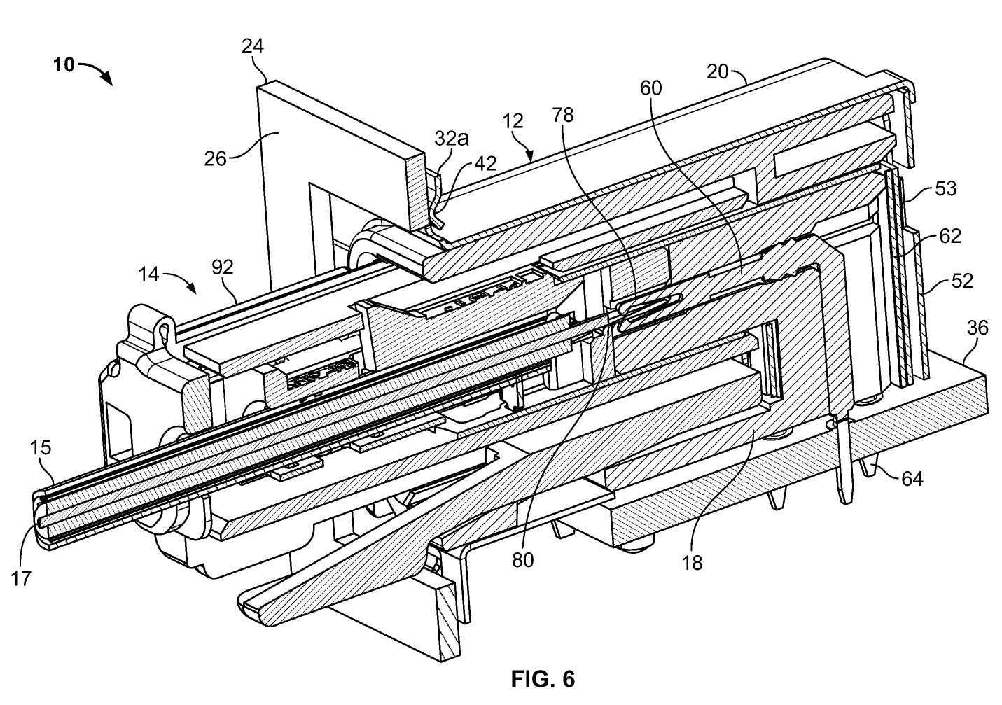

The receptacle contact 60 includes an attachment feature 72 formed integrally with an intermediate portion 74. In this exemplary embodiment, the attachment feature 72 is a post. The post 72 is configured to be received and retained within a throughhole (not shown) formed in circuit board 36 (FIG. 3) and conductively connected to a conductive pathway (not shown) thereof. The intermediate portion 74 is joined with a right-angled transition portion 76, which is joined with a clip portion 78. In another embodiment, the receptacle contact 60 includes another or alternate attachment feature (not shown), such as a contact tail or conductive pad, to surface mount the receptacle contact 60 to circuit board 36. The clip portion 78 is configured to mate with a conductor termination feature 80 (FIG. 6) of plug cable 15 (FIG. 6). In one embodiment, the receptacle contact 60 is a signal contact.

The inner ground shield 62 includes side panels 82, a back panel (not shown), and a top panel 84. The side panels 82, back panel, and top panel 84 define a central contact chamber 86. The side panels 82 include attachment features 88. In this exemplary embodiment, the attachment features 88 are posts. The posts 88 extend downwardly from the side panels 82 and are configured to be received and retained by vias or throughholes (not shown) formed within the circuit board 36 to ground the inner ground shield 62 to ground conductive pathways (not shown) thereof In this exemplary embodiment, the inner ground shield 62 includes four posts 88, however, in another embodiment, the inner ground shield 62 may include one or more posts 88. In yet another embodiment, the attachment features may be a contact tails, conductive pads or other similar feature to surface mount the receptacle contact 60 to circuit board 36.

The inner ground shield 62 further includes compliant tabs 90 (a compliant tab is present, but not shown, on the opposite side of the inner ground shield 62). The compliant tabs 90 are received in recesses (not shown) in the dielectric cover 18 to assist in securing the inner ground shield 62 thereto.

FIG. 6 shows a cross sectional view of the mated electrical connector 10 of FIG. 1. As can be seen in FIG. 6, the receptacle contact 60 and inner ground shield 62 are disposed within the dielectric cover 18. The receptacle contact 60 is conductively isolated from the inner ground shield 62 and the outer ground shield 20 by the dielectric cover 18. The inner ground shield 62 is disposed between the receptacle contact 60 and the outer ground shield 20. The rear shield contact feature 53 of the outer ground shield 20 is in contact with the inner ground shield 62.

The exemplary receptacle connector 12 described above is not intended to limit the invention to the described configuration, but it should be apparent that modifications to the receptacle connector 12 may be made without departing from the scope of the invention. For example, in another embodiment, the outer shield 20 may not include a rear wall and the other components may accordingly be modified as would be appreciated by one of ordinary skill in the art. In yet another embodiment, the receptacle connector 12 may be configured to receive plug connector 14 from direction A as shown in FIG. 1.

The plug connector 14 is more fully described referring to FIGS. 3 and 6. The plug connector 14 includes a plug outer housing 92 and a wire or cable 15 securely retained and terminated therein. The cable 15 may be a coaxial cable. The cable 15 includes a plug conductor 17, which is terminated to a conductor termination feature 80. The conductor termination feature 80 is configured to mate with clip portion 78 of receptacle contact 60 of the receptacle connector 12 when the receptacle connector 12 and plug connector 14 are mated as shown in FIG. 6. In this exemplary embodiment, the conductor termination feature 80 is a blade contact. In another embodiment, the conductor termination feature 80 may be any terminal or contact configured to mate with a corresponding receptacle contact 60.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A shielded electrical connector, comprising:
a receptacle connector comprising:
a dielectric cover comprising a plug reception cavity having an opening thereto;
a receptacle contact disposed within the dielectric cover;
an inner ground shield disposed between the receptacle contact and the dielectric cover; and
an outer ground shield surrounding the dielectric cover;
wherein the outer ground shield further comprises at least one compliant grounding feature proximate to the dielectric cover opening and an attachment feature;
wherein the at least one compliant grounding feature is configured to positively engage an interior surface of a module wall without contacting an exterior surface of the module wall; and
a plug connector comprising a plug conductor terminated therewithin;
wherein the plug connector is configured to mate with the receptacle connector to establish an electrical connection between the plug conductor and the receptacle contact.

2. The shielded electrical connector of claim 1, wherein the at least one grounding feature is a tab comprising a compliant grounding feature.

3. The shielded electrical connector of claim 2, wherein the compliant grounding feature is a spring beam.

4. The shielded electrical connector of claim 1, wherein the opening of the plug reception cavity is proximate to an opening in a module wall and the grounding feature is configured to ground the outer ground shield to the module wall.

5. (canceled)

6. The shielded electrical connector of claim 1, wherein the outer ground shield includes a contact feature that conductively contacts the inner ground shield.

7. The shielded electrical connector of claim 1, wherein the outer ground shield comprises a top wall, opposed side walls, a rear wall, and a bottom wall.

8. The shielded electrical connector of claim 7, wherein a grounding feature is disposed adjacent the top wall, grounding features are disposed adjacent the side walls, and a grounding feature is disposed adjacent the bottom wall.

9. The shielded electrical connector of claim 1, wherein the attachment feature is configured to electrically ground the outer ground shield to a substrate.

10. The shielded electrical connector of claim 1, wherein the inner ground shield comprises an attachment feature configured to electrically ground the inner grounding shield to a substrate.

11. The shielded electrical connector of claim 1, wherein the attachment feature is configured to ground the outer grounding shield to a substrate.

12. The shielded electrical connector of claim 11, wherein the substrate is a printed circuit board.

13. A shielded receptacle connector, comprising:
a dielectric cover comprising a plug reception cavity having an opening thereto;
a receptacle contact disposed within the dielectric cover;
an inner ground shield disposed between the receptacle contact and the dielectric cover; and
an outer ground shield surrounding the dielectric cover;
wherein the outer ground shield further comprises at least one compliant grounding feature proximate to the dielectric cover shield front opening and an attachment feature;
wherein the at least one compliant grounding feature is configured to positively engage an interior surface of a module wall without contacting an exterior surface of the module wall.

14. The shielded receptacle connector of claim 13, wherein the at least one grounding feature is a tab comprising a compliant grounding feature.

15. The shielded receptacle connector of claim 14, wherein the compliant grounding feature is a spring beam.

16. The shielded receptacle connector of claim 13, wherein the opening of the plug reception cavity is proximate to an opening in a module wall and the grounding feature is configured to ground the outer ground shield to the module wall.

17. (canceled)

18. The shielded receptacle connector of claim 13, wherein the outer ground shield includes a contact feature configured to conductively contact the inner ground shield.

19. The shielded receptacle connector of claim 13, wherein the outer ground shield comprises a top wall, opposed side walls, a rear wall, and a bottom wall

20. The shielded receptacle connector of claim 19, wherein a grounding feature is disposed adjacent the top wall, grounding features are disposed adjacent the opposed side walls, and a grounding feature is disposed adjacent the bottom wall.

21. The shielded receptacle connector of claim 13, wherein the attachment feature is configured to electrically ground the outer ground shield to a substrate.

22. The shielded receptacle connector of claim 13, wherein the inner ground shield comprises an attachment feature configured to electrically ground the inner grounding shield to a substrate.

23. The shielded receptacle connector of claim 21, wherein the substrate is a printed circuit board.
